(19) United States
(12) Patent Application Publication
(10) Pub. No.: US 2018/0126669 A1
(43) Pub. Date: May 10, 2018

(54) APPARATUS AND METHOD FOR MANUFACTURING FIBER REINFORCED PLASTIC PRODUCT

(71) Applicant: Hyundai Motor Company, Seoul (KR)

(72) Inventors: Young Ho CHOI, Seongnam-Si (KR); Min Jin Choi, Bucheon-Si (KR); Hee Joon Lee, Seoul (KR); Yong Beom Lee, Seoul (KR)

(73) Assignee: Hyundai Motor Company, Seoul (KR)

(21) Appl. No.: 15/375,515

(22) Filed: Dec. 12, 2016

(30) Foreign Application Priority Data
Nov. 7, 2016 (KR) 10-2016-0114718

(51) Int. Cl. B29C 67/00; B33Y 10/00; B33Y 30/00; B33Y 70/00

(52) U.S. Cl. CPC B29C 67/0081; B33Y 10/00; B29K 2105/14; B33Y 70/00; B33Y 30/00

(57) ABSTRACT

An apparatus and the method for manufacturing a fiber reinforced plastic product may manufacture a fiber reinforced plastic product by using a 3D printing method and enable the fiber reinforced plastic product to have mechanical physical properties against X, Y, and Z-direction loads, by uniformly arranging reinforcing fibers in the X, Y, and Z directions in respect of orientation distribution, and then by spraying a photocurable resin over the reinforcing fibers so that the reinforcing fibers are impregnated with the photocurable resin.

### CROSS-REFERENCE TO RELATED APPLICATION

The present application claims priority to Korean Patent Application No. 10-2016-0114718 filed on Sep. 7, 2016, the entire contents of which is incorporated herein for all purposes by this reference.

### BACKGROUND

### Field of the Invention

The present invention relates to an apparatus and a method for manufacturing a fiber reinforced plastic product. More particularly, it relates to an apparatus and a method for manufacturing a fiber reinforced plastic product, which are configured for manufacturing a fiber reinforced plastic product having excellent longitudinal strength by using a 3D printing method.

### Description of Related Art

In general, as a representative method of manufacturing a fiber reinforced plastic product, there are an injection molding method and a compression molding method.

In the case of the compression molding method, lengths of reinforcing fibers are intactly maintained during processes, and thus it is possible to implement a sufficient reinforcing effect of the reinforcing fiber after molding, but the compression molding method is mainly used for forming a component having a simple shape in the form of a sheet, and as a result, there is a limitation in manufacturing fiber reinforced plastic products having various shapes, and most of the reinforcing fibers have an isotropic orientation.

The injection molding method is very useful to manufacture a component having a complicated shape in comparison with the compression molding, but the injection molding method has a disadvantage in that the reinforcing fibers are cut while a thermoplastic resin passes through an injection molding screw, which causes deterioration in reinforcing effect, and most of the reinforcing fibers are oriented in an isotropic manner, or some of the reinforcing fibers are oriented in parallel with a direction in which the resin flows.

Meanwhile, in a case in which a fiber reinforced plastic product is manufactured by using a 3D printer, reinforcing fibers in the form of powder are oriented in parallel with a direction in which a nozzle of the printer ejects resin, and as a result, there is a disadvantage in that a Z-direction strength of the manufactured product deteriorates.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus and a method for manufacturing a fiber reinforced plastic product, which manufacture a fiber reinforced plastic product by using a 3D printing method and enable the fiber reinforced plastic product to have excellent mechanical physical properties against X, Y, and Z-direction loads, by uniformly arranging reinforcing fibers in the X, Y, and Z directions in respect of orientation distribution, and then by spraying a photocurable resin over the reinforcing fibers so that the reinforcing fibers are impregnated with the photocurable resin.

In one aspect, various aspects of the present invention are directed to providing an apparatus for manufacturing a fiber reinforced plastic product, the apparatus including: a storage chamber in which reinforcing fibers in a form of powder are stored and a first stand is positioned at a bottom of the storage chamber to be moved upward and downward; a processing chamber which is a space in which the fiber reinforced plastic product is formed by repeatedly laminating layers predetermined times by a 3D printing method and a second stand is positioned at a bottom of the processing chamber to be movable upward and downward; a mesh which is positioned at a position at the periphery of the processing chamber to be moved forward toward a position above a surface of the second stand or a preformed laminated surface on the second stand, and sifts the reinforcing fiber powder so that the reinforcing fiber powder has orientation distribution in the X, Y, and Z directions; a roller which pushes and conveys the reinforcing fiber powder stored in the storage chamber toward an upper side of the mesh; a nozzle which sprays a photocurable resin, based on 3D printing coordinate data, onto the reinforcing fiber powder which passes through the mesh and then is placed on the surface of the second stand or the preformed laminated surface on the second stand; and a ultraviolet (UV) irradiation device which is mounted at the periphery of the nozzle and radiates UV radiation toward the photocurable resin.

In an exemplary embodiment, an actuator, which moves the mesh forward or rearward, may be connected to an outside end of the mesh.

In another exemplary embodiment, the mesh may be provided to have a structure in which a size of an air gap of the mesh is 1.5 to 3 times as large as a height of a layer of the fiber reinforced plastic product which is formed by being laminated once.

In another aspect, various aspects of the present invention are directed to providing a method for manufacturing a fiber reinforced plastic product, the method including: i) preparing reinforcing fibers in a form of powder and storing the reinforcing fibers in a storage chamber; ii) disposing a mesh on a surface of a second stand of a processing chamber or a preformed laminated surface on the second stand; iii) conveying the reinforcing fiber powder in the storage chamber toward a position above the mesh; iv) sifting, by the mesh, the reinforcing fiber powder so that the reinforcing fibers are placed on the surface of the second stand or the preformed laminated surface on the second stand while having orientation distribution in X, Y, and Z directions; and v) removing the mesh, spraying, by a nozzle, a photocurable resin, based on 3D printing coordinate data, onto the reinforcing fiber powder placed on the second stand or the preformed laminates surface on the second stand, and simultaneously, radiating, by a UV irradiation device, UV radiation toward the photocurable resin.

In an exemplary embodiment, in step i), the reinforcing fibers may be prepared such that a length of the reinforcing fiber is 0.3 to 1.3 times as large as a height of the fiber reinforced plastic product which is formed by being laminated once.

In another exemplary embodiment, in step ii), the mesh may be provided to have a structure in which a size of an air gap of the mesh is 1.5 to 3 times as large as a height of a layer of the fiber reinforced plastic product which is formed by being laminated once.

In still another exemplary embodiment, the method may further include, between step iv) and step v), applying an electric field between the mesh, which includes a metallic material, and the second stand, such that longitudinal (Z direction) orientation of the reinforcing fibers is induced.

In yet another exemplary embodiment, one or two or more of carbon black, glass bubbles, and glass beads, which are spherical reinforcing materials, may be mixed with the reinforcing fiber powder for a reinforcing effect.

Through the aforementioned technical solutions, various aspects of the present invention are directed to providing the effects below.

According to an exemplary embodiment of the present invention, a fiber reinforced plastic product is formed by utilizing a 3D printing method, by uniformly arranging the reinforcing fibers in X, Y, and Z directions in respect of orientation distribution by using the mesh, and then spraying the photocurable resin onto the reinforcing fibers so that the photocurable resin is impregnated into the reinforcing fibers, and as a result, excellent mechanical physical properties may be exhibited against X, Y, and Z-direction loads, and longitudinal tensile strength, that is, Z-direction tensile strength may be greatly improved.

Other aspects and exemplary embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuel derived from resources other than petroleum). As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1, FIG. 2, FIG. 3, FIG. 4, and FIG. 5 are schematic views sequentially illustrating processes of forming a fiber reinforced plastic product by laminating layers by using an apparatus for manufacturing a fiber reinforced plastic product according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the present invention will be described in detail.

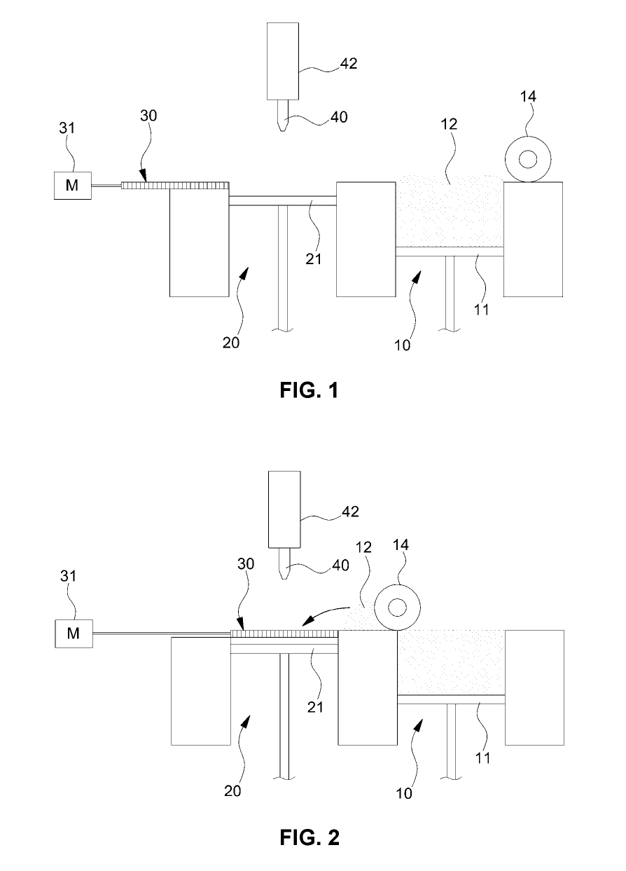

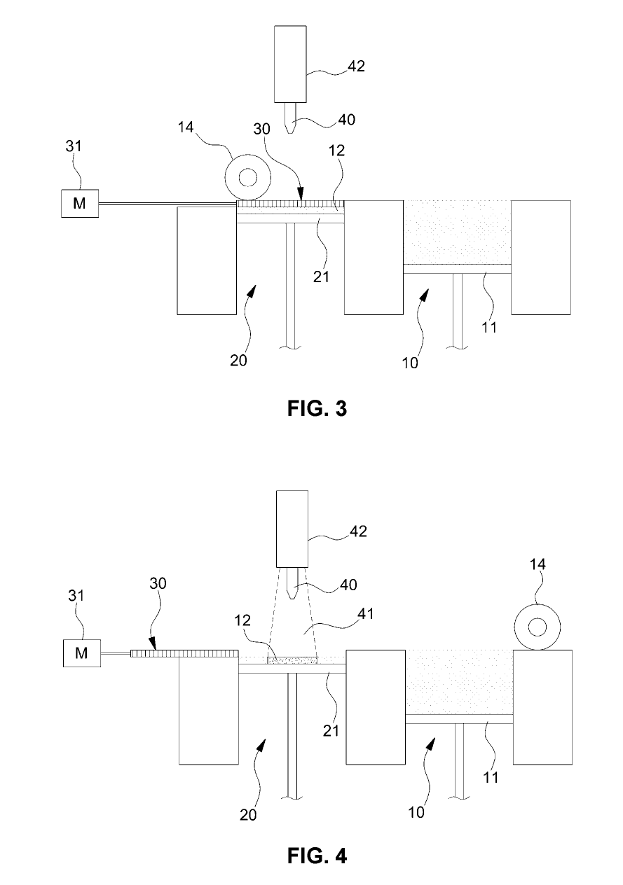

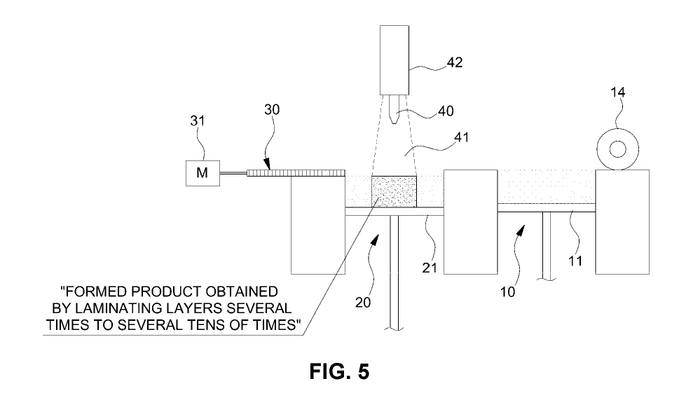

FIG. 1, FIG. 2, FIG. 3, FIG. 4, and FIG. 5 are schematic views illustrating an apparatus for manufacturing a fiber reinforced plastic product according to an exemplary embodiment of the present invention, in which reference numeral 10 indicates a storage chamber, and a reference numeral 20 indicates a processing chamber.

The storage chamber 10 stores reinforcing fiber (e.g., carbon fiber) powder, and a first stand 11 is positioned at a bottom of the storage chamber 10 to be movable upward and downward by an operation of a hydraulic or pneumatic cylinder.

Therefore, when the first stand 11 is moved upward in a state in which reinforcing fiber powder 12 is stored in the storage chamber 10, the reinforcing fiber powder is partially raised upward from the storage chamber 10.

The processing chamber 20 is a space for forming a three-dimensional shape fiber reinforced plastic product by laminating layers predetermined times by using a 3D printing method, and a second stand 21 for forming a fiber reinforced plastic product by laminating layers is positioned at a bottom of the processing chamber 20 to be movable upward and downward by an operation of a hydraulic or pneumatic cylinder.

In the instant case, a roller 14 is positioned at an upper side of the storage chamber 10 to be movable forward and rearward by a typical actuator means, and the roller 14 serves to convey the reinforcing fiber powder 12, which is raised upward from the storage chamber 10, toward the processing chamber 20.

A mesh 30 is positioned at a first side of the processing chamber 20 to be movable forward and rearward, and an actuator 31 for moving the mesh 30 forward or rearward is connected to an outside end of the mesh 30.

The mesh 30 serves to sift the reinforcing fiber powder 12 from the storage chamber 10 in a state in which the mesh 30 is moved forward toward a position above a surface of the second stand 21 or a preformed laminated surface on the second stand 21, such that the reinforcing fiber powder 12 has orientation distribution in X, Y, and Z directions.

Meanwhile, a nozzle 40, which sprays a photocurable resin 41, is positioned at a position above the processing chamber 20, a UV irradiation device 42, which radiates UV radiation toward the photocurable resin 41, is coupled to an upper end portion of the nozzle 40, and the nozzle 40 and the UV irradiation device 42 are positioned to be movable in a desired direction based on a predetermined 3D printing coordinate by a typical actuator.

In more detail, the nozzle 40 is moved based on predetermined 3D printing coordinate data and sprays the photocurable resin onto the reinforcing fiber powder which passes through the mesh 30 and then is placed on the surface of the second stand 21 or on the preformed laminated surface on the second stand 21. At the same time, the UV irradiation device 42 serves to irradiate the photocurable resin, which is sprayed onto and impregnated in the reinforcing fiber powder, with the UV radiation, curing the photocurable resin.

Here, an operation flow of the apparatus for manufacturing a fiber reinforced plastic product, which includes the aforementioned configurations, will be described below.

First, the storage chamber 10 is filled with the reinforcing fiber powder 12.

In particular, one or two or more of carbon black, glass bubbles, and glass beads, which are spherical reinforcing materials, may be mixed and used with the reinforcing fiber powder to further obtain the reinforcing effect.

Next, the first stand 11 of the storage chamber 10 is moved upward to allow the reinforcing fiber powder 12 to be partially raised upward from the storage chamber 10, and simultaneously, the second stand 21 of the processing chamber 20 is moved upward to a highest position (see FIG. 1).

Next, the mesh 30 is moved forward by the operation of the actuator 31 and then positioned above the second stand 21 to be spaced apart from the second stand 21. Thereafter, when the roller 14 is moved forward, the reinforcing fiber powder 12 raised upward from the storage chamber 10 is conveyed onto the mesh 30 by forward driving power of the roller 14 (see FIG. 2).

Therefore, the reinforcing fiber powder 12 conveyed onto the mesh 30 passes through the mesh 30 and then is placed on the surface of the second stand 21 (see FIG. 3), and the placed reinforcing fiber powder 12 has the orientation distribution in the X, Y, and Z directions.

Of course, the fiber reinforced plastic product according to an exemplary embodiment of the present invention is formed by repeatedly laminating predetermined layers, and as a result, in a case in which at least one preformed laminated surfaces are present on the surface of the second stand 21, the reinforcing fiber powder passing through the mesh 30 is placed on the preformed laminated surface on the second stand 21 while having the orientation distribution in the X, Y, and Z directions.

In particular, after the reinforcing fiber powder passes through the mesh 30 and then is placed on the surface of the second stand 21 or on the preformed laminated surface on the second stand 21 while having the orientation distribution in the X, Y, and Z directions, an electric field of approximately 20 to 40 kV/cm is applied between the mesh, which includes a metallic material, and the second stand, such that longitudinal (Z direction) orientation of the reinforcing fibers may be further induced.

Next, after the mesh 30 is moved rearward by the operation of the actuator 31 and removed from the second stand 21, the nozzle 40 positioned above the second stand 21 sprays the photocurable resin 41 onto the reinforcing fiber powder 12 while being moved based on the predetermined 3D printing coordinate data, and simultaneously, the UV irradiation device 42 irradiates the photocurable resin 41, which is sprayed onto and impregnated into the reinforcing fiber powder 12, with UV radiation, curing the photocurable resin 41 (see FIG. 4).

Meanwhile, the reinforcing fiber, which is stored in the storage chamber 10 and then passes through the mesh 30 and then is placed on the surface of the second stand 21 or on the preformed laminated surface on the second stand 21, needs to have a length of 0.3 to 1.3 times (0.8 times, on average) as large as a height of a layer of the fiber reinforced plastic product which is formed by being laminated once. The reason is that when the length is smaller than 0.3 times the height, the photocurable resin 41 is not easy to permeate between the reinforcing fibers because apparent specific gravity of the reinforcing fiber powder passing through the mesh 30 is increased, and longitudinal strength of the formed laminated product may be weakened because the reinforcing fibers are excessively oriented in a lateral direction (X-Y direction=plane direction), and when the length is greater than 1.3 times the height, lateral strength of the formed laminated product may be weakened because the reinforcing fibers are excessively oriented in a longitudinal direction (Z direction).

The mesh 30 has a plurality of air gaps, each air gap of the mesh 30 has a size of 1.5 to 3 times as large as the height of the layer of the fiber reinforced plastic product which is formed by being laminated once. The reason is that when the size is smaller than 1.5 times the height, the air gap is clogged or the reinforcing fibers passing through the air gap are excessively oriented in a longitudinal direction, and when the size is greater than 3 times the height, the longitudinal strength of the formed laminated product is weakened because the amount of reinforcing fibers oriented in the longitudinal direction is decreased, and the photocurable resin is excessively diffused between the reinforcing fibers (excessively diffused in the lateral direction) because gaps between the reinforcing fibers are excessively increased as the reinforcing fibers easily pass through the air gaps, and as a result, product formability deteriorates, and roughness of the product (surface roughness) deteriorates.

After one laminating forming step of spraying the photocurable resin 41 onto the reinforcing fiber powder 12 placed on the surface of the second stand 21 and then curing the photocurable resin 41 by irradiating the photocurable resin 41 with UV radiation, the same process is repeatedly performed predetermined times or predetermined tens of times, and as a result, the final fiber reinforced plastic product is completely manufactured (see FIG. 5).

Here, the present invention will be described in more detail with reference to Examples.

### Example 1

Carbon fibers having normal distribution with an average length of 0.1 mm are prepared in a form of powder, a mesh having air gaps of 0.35 mm×0.35 mm is prepared, and a work table for laminating forming is positioned below the mesh.

Next, the carbon fiber powder having the average length of 0.1 mm passes through the air gaps of 0.35 mm×0.35 mm of the mesh, such that the carbon fiber powder is placed at a height of 0.13 mm on the work table below the mesh.

Next, a urethane acrylate resin, which is photocurable resin, is printed onto the carbon fiber powder placed on the work table in the form of micro-droplets having a size of approximately 40 μm by a piezoelectric jet nozzle.

Consecutively, the urethane acrylate resin printed onto the carbon fiber powder is cured by being irradiated with UV radiation, and as a result, a lateral tensile specimen and a longitudinal tensile specimen according to Example 1 are completely manufactured.

In the instant case, the lateral tensile specimen is manufactured to be in parallel with the surface of the work table, and the longitudinal tensile specimen is manufactured by repeatedly laminating layers in a height direction of the work table. An ambient temperature of a chamber in which the photocurable resin is printed is maintained at a temperature of 80° C.

### Example 2

A tensile specimen was manufactured in the same manner as the specimen according to Example 1, except that glass fiber powder having normal distribution with an average diameter of 20 μm and an average length of 0.12 mm was prepared.

### Example 3

A tensile specimen was manufactured in the same manner as the specimen according to Example 1, except that an electric field of 40 kV was applied between the mesh and the work table in the step of allowing the carbon fiber powder to pass through the mesh and supplying the carbon fiber power at a height of one layer (a height of a layer laminated once) onto the work table, like Example 1.

### Comparative Example 1

A tensile specimen was manufactured in the same manner as the specimen according to Example 1, except that no mesh was used.

### Comparative Example 2

A tensile specimen was manufactured in the same manner as the specimen according to Example 1 except that carbon fiber powder having an average length of 1 mm was prepared.

### Comparative Example 3

A tensile specimen was manufactured in the same manner as the specimen according to Example 2 except that glass fiber powder having an average length of 1.5 mm was prepared.

### Test Example

Mechanical physical properties including longitudinal (Z direction) tensile strength and lateral (X and Y directions) tensile strength, surface roughness, and specific gravity of the tensile specimens manufactured in accordance with Examples 1 to 3 and Comparative Examples 1 to 3 were measured by using typical equipment, and the measurement results are shown in the following Table 1.

TABLE 1

| | | | | Comparative | Comparative | Comparative |
|---|---|---|---|---|---|---|
| | Example 1 | Example 2 | Example 3 | Example 1 | Example 2 | Example 3 |
| Longitudinal | 135 | 66 | 152 | 22 | 27 | 25 |
| (Z direction) | | | | | | |
| Tensile Strength | | | | | | |
| (MPa) | | | | | | |
| Lateral | 139 | 71 | 123 | 117 | 140 | 56 |
| (X and Y directions) | | | | | | |
| Tensile Strength | | | | | | |
| (MPa) | | | | | | |
| Surface Roughness | 400 | 180 | 450 | 300 | 100 | 100 |
| Specific Gravity | 1.45 | 1.91 | 1.38 | 1.36 | 1.29 | 1.83 |

As shown in the above Table 1, it can be seen that Examples 1 to 3 according to an exemplary embodiment of the present invention exhibit excellent mechanical physical properties in respect of the longitudinal tensile strength in comparison with Comparative Examples 1 to 3, and in the case of Comparative Examples 1 to 3 in which the photocurable resin is impregnated into the reinforcing fiber powder in a state in which no mesh is used, permeability of an assembly configured by the reinforcing fiber powder is irregular, and pores are formed at portions where the photocurable resin cannot flow in, and as a result, the specific gravity is lower than that in Examples 1 and 2, and mechanical strength including longitudinal tensile strength is also lower than that in Examples 1 and 2.

In the case of Example 3, it can be seen that some reinforcing fibers are additionally oriented in a direction of an electric field (Z direction) by the electric field, such that longitudinal tensile strength is most excellent. Therefore, it can be seen that mechanical physical properties of the formed laminated product may be adjusted for each direction by adjusting the electric field being applied.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for manufacturing a fiber reinforced plastic product, the apparatus comprising:
a storage chamber in which reinforcing fiber powder is stored and a first stand is positioned at a bottom of the storage chamber to be moved upward and downward;
a processing chamber which is a space in which the fiber reinforced plastic product is formed by repeatedly laminating layers predetermined times by a 3D printing method and a second stand is positioned at a bottom of the processing chamber to be movable upward and downward;
a mesh which is positioned at a position at a periphery of the processing chamber to be moved forward toward a position above a surface of the second stand or a preformed laminated surface on the second stand, and sifts the reinforcing fiber powder so that the reinforcing fiber powder has orientation distribution in X, Y, and Z directions;
a roller which pushes and conveys the reinforcing fiber powder stored in the storage chamber toward an upper side of the mesh;
a nozzle which sprays a photocurable resin, based on 3D printing coordinate data, onto the reinforcing fiber powder which passes through the mesh and then is placed on the surface of the second stand or the preformed laminated surface on the second stand; and
an ultraviolet (UV) irradiation device which is mounted at a periphery of the nozzle and radiates UV radiation toward the photocurable resin.

2. The apparatus of claim 1, wherein an actuator, which moves the mesh forward or rearward, is connected to an outside end portion of the mesh.

3. The apparatus of claim 1, wherein the mesh is provided to have a structure in which a size of an air gap of the mesh is approximately 1.5 to 3 times as large as a height of a layer of the fiber reinforced plastic product which is formed by being laminated once.

4. A method for manufacturing a fiber reinforced plastic product, the method comprising:
i) preparing reinforcing fiber powder and storing the reinforcing fibers in a storage chamber;
ii) disposing a mesh on a surface of a second stand of a processing chamber or a preformed laminated surface on the second stand;
iii) conveying the reinforcing fiber powder in the storage chamber toward a position above the mesh;
iv) sifting, by the mesh, the reinforcing fiber powder so that reinforcing fibers of the reinforcing fiber powder are placed on the surface of the second stand or the preformed laminated surface on the second stand while having orientation distribution in X, Y, and Z directions; and
v) removing the mesh, spraying, by a nozzle, a photocurable resin, based on 3D printing coordinate data, onto the reinforcing fiber powder placed on the second stand or the preformed laminates surface on the second stand, and simultaneously, radiating, by a ultraviolet (UV) irradiation device, UV radiation toward the photocurable resin.

5. The method of claim 4, wherein in step i), the reinforcing fibers are prepared such that a length of the reinforcing fiber is approximately 0.3 to 1.3 times as large as a height of the fiber reinforced plastic product which is formed by being laminated once.

6. The method of claim 4, wherein in step ii), the mesh is provided to have a structure in which a size of an air gap of the mesh is approximately 1.5 to 3 times as large as a height of the fiber reinforced plastic product which is formed by being laminated once.

7. The method of claim 4, further comprising:
between step iv) and step v), applying an electric field between the mesh, which includes a metallic material, and the second stand, such that longitudinal (Z direction) orientation of the reinforcing fibers is induced.

8. The method of claim 4, wherein one or two or more of carbon black, glass bubbles, and glass beads, which are spherical reinforcing materials, are mixed with the reinforcing fiber powder for a reinforcing effect.
